(19) United States
(12) Patent Application Publication
(10) Pub. No.: US 2010/0078507 A1
(43) Pub. Date: Apr. 1, 2010

(54) Heated and insulated fuel injector

(76) Inventor: Jason C. Short, Henrietta, NY (US)

Correspondence Address: DELPHI TECHNOLOGIES, INC;LEGAL STAFF - M/C 483-400-402, 5725 DELPHI DRIVE, PO BOX 5052, TROY, MI, 48007, US

(21) Appl. No.: 12/286,246

(22) Filed: Sep. 29, 2008

(51) Int. Cl. B05B 1/30

(52) U.S. Cl. 239/584; 123/549; 239/132

(57) ABSTRACT

A fuel injector having a fuel heater and an insulating air jacket. The fuel injector includes a fuel heater disposed on the outside of the injector body. The injector body conducts heat energy from the heater element to the fuel chamber preferably via cooling fins that protrude into the fuel path. The heater and injector body are disposed within a closed air jacket formed with the shell of the injector. As air has low thermal conductivity, this feature directs most of the heat energy radially inward through the wall of the injector body into the fuel. The injector is especially useful in injecting low-volatility fuels into internal combustion engines under low-temperature conditions.

### TECHNICAL FIELD

The present invention relates to fuel injectors for injecting fuels into internal combustion engines; more particularly, to fuel injectors incorporating means for supplying heat to fuel passing therethrough; and most particularly, to a fuel injector having both heater means and an insulating air jacket for injecting low-volatility fuels such as ethanol.

### BACKGROUND OF THE INVENTION

Internal combustion engines that are fueled by 100% ethanol (E100) experience fuel vaporization problems in cold temperatures. This causes poor engine starting. Several solutions are known in the prior art that aid in cold weather starting of ethanol-fueled engines. Some engines are equipped with a pure gasoline injection system, which is utilized under cold start conditions. Another way to start an ethanol-fueled engine is to add heat to the fuel or to the combustion chamber. This can be done in any of several ways, for example, by lowering the pressure in the combustion chamber and relying on friction and compression heating to aid in the ethanol vaporization; or, by installing a heater in the fuel system to add heat to the fuel before being injected; or, by spraying fuel directly onto a heat source, thus causing the liquid fuel to vaporize on contact.

Increasing the fuel temperature before injection improves vaporization at low temperatures and can reduce cold-start emissions by up to 40% during the typical 50-second EPA cold start cycle.

There are several challenges associated with incorporating a heater into a standard fuel injector. The fuel side of an injector is hermetically sealed, typically by welding together the stainless steel components of the injector. An optimum fuel heater design would locate the heater inside the fuel portion of the injector, but the electric leads that provide energy to the heater must be routed out of the injector while maintaining the integrity of the hermetic seal of the fuel side of the injector. One way of obviating this would be simply to incorporate a heater onto the outside of the injector body. A problem with this arrangement is that stainless steel has relatively low thermal conductivity in comparison to other metals. Thus, the heat energy generated by an exterior heater element cannot be efficiently conducted to the fuel through the outside wall of the injector, which typically is formed of stainless steel, without some insulative assist.

What is needed in the art is a fuel injector having a fuel heater wherein the hermetic seal of the fuel flow path is maintained and wherein outward radial heat loss is minimized.

It is a principal object of the present invention to improve the startability and reduce the cold-start emission levels of an internal combustion engine fueled by low-volatility fuels such as ethanol, ethanol/gasoline mixtures, and diesel fuel.

### SUMMARY OF THE INVENTION

Briefly described, a fuel injector having both an internal heater and an insulating air jacket in accordance with the present invention includes a fuel heater inside the discharge end of the injector. The injector body conducts heat energy from the heater element to the fuel chamber preferably via cooling fins that protrude into the fuel path. The heater and injector body are disposed within a closed air jacket formed with the shell of the injector. As air has a low thermal conductivity, this feature minimizes radiantly-outward heat loss and directs most of the heat energy conductively inward into the fuel.

### BRIEF DESCRIPTION OF THE DRAWINGS

The present invention will now be described, by way of example, with reference to the accompanying drawings, in which:

FIG. 1 is an elevational cross-sectional view of a first embodiment in accordance with the present invention;

FIG. 2 is an exploded isometric view of the first embodiment shown in FIG. 1;

FIG. 3 is a side elevational view of a second embodiment in accordance with the present invention;

FIG. 4 is an exploded isometric view of the second embodiment shown in FIG. 3;

FIG. 5 is an elevational view of a heater in accordance with the present invention;

FIG. 6 is a cross-sectional view of the heater shown in FIG. 5;

FIG. 7 is a top view of the heater shown in FIG. 5; and

FIG. 8 is an elevational cross-sectional view of a subassembly in accordance with the second embodiment shown in FIGS. 3 and 4.

Corresponding reference characters indicate corresponding parts throughout the several views. The exemplifications set out herein illustrate two currently-preferred embodiments of the invention, and such exemplifications are not to be construed as limiting the scope of the invention in any manner.

### DESCRIPTION OF THE PREFERRED EMBODIMENTS

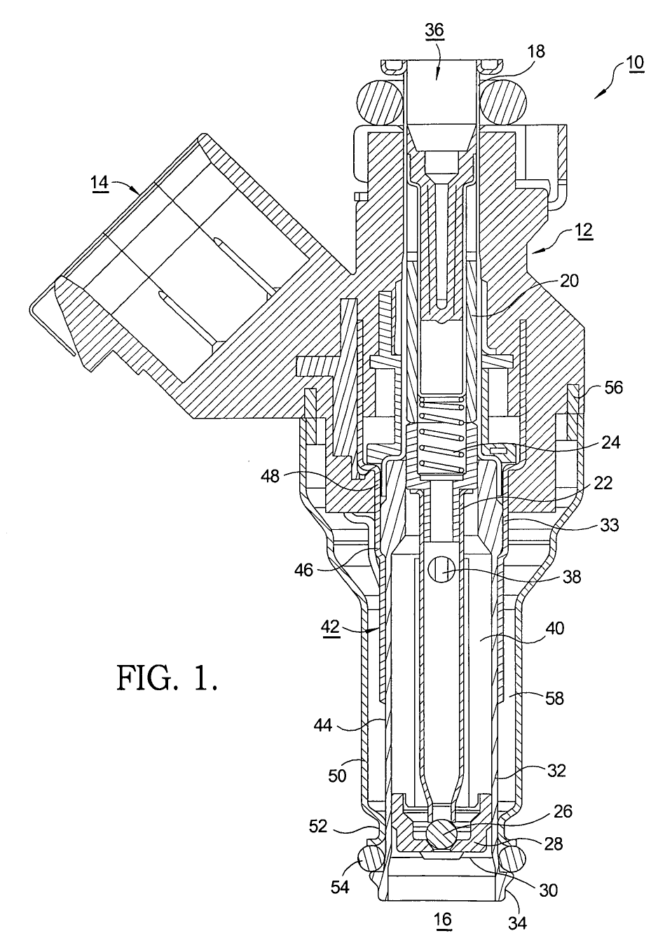

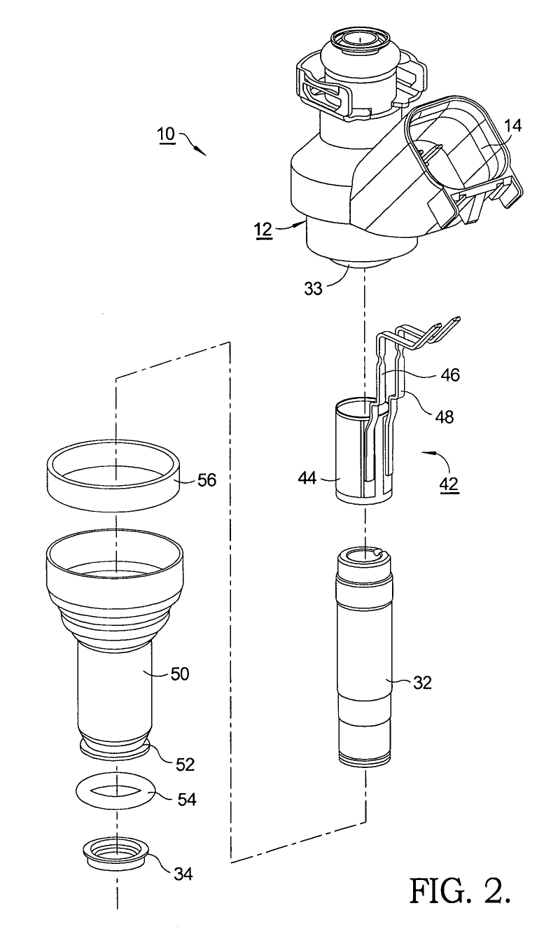

Referring to FIGS. 1 and 2, a first embodiment 10 is shown, in accordance with the present invention, of a heated and insulated fuel injector suitable for injecting low-volatility fuels. Most of the components of fuel injector 10 are known in the art. These include an upper solenoid sub-assembly 12 including a socket 14 for connection to a wiring harness (not shown) of an internal combustion engine 16; a fuel entry tube 18; solenoid armature 20; valve 22; return spring 24; valve head 26; valve seat 28; disperser plate 30; injector body 32; and retainer 34. Body 32 is received in and welded to fuel entry tube 18. Injection molded upper solenoid sub-assembly 12 is then attached to body/fuel tube assembly via a weld on snout 33.

Fuel 36 from a fuel rail (not shown) enters at fuel entry tube 18 and flows through armature 20, spring 24, valve 22, and out through opening 38 in valve 22 into flow space 40. Fuel from flow space 40 is metered past valve seat 28 by retraction of valve 22 and valve head 26 from valve seat 28 via actuation of solenoid armature 20 and compression of spring 24. All of the above is well-established in the prior art and need not be elaborated upon further.

In accordance with the present invention, a heater sub-assembly 42 comprising a resistance element 44, preferably comprising a thin, ceramic, partial cylinder, and first and second terminal contact pads 46, 48, surrounds injector body 32 in close proximity thereto. Terminals 77, 78 are a part of sub-assembly 12, and attach to contact pads 46, and 48 respectively. The terminals allow passage of electrical energy between the heater and power socket 14. An injector shell 50 having an inside diameter greater than the outside diameter of injector body 32 includes a lower crimp 52 for centering injector body 32 and providing a seat for a lower O-ring 54 which is retained between lower crimp 52 and retainer 34. Shell 50 mates to solenoid sub assembly 12 via a seal ring 56, and is welded to body 32 near crimp 52, thereby creating an insulative jacketing air space 58 between shell 50 and heater sub-assembly 42. The upper seal may also be achieved by an adhesive or by insert molding a metal ring into solenoid sub-assembly 12. Preferably, injector body 32 and shell 50 are formed of stainless steel. Alternatively, body 32 may be formed of a metal more thermally-conductive than stainless steel that is also resistant to corrosion by fuels such as ethanol, for example, titanium alloy.

In operation, heat generated by electrical resistance in heater sub-assembly 42 is transferred via thermal conductance through the wall of body 32 and into fuel 36 flowing through flow space 40. The operating parameters for sub-assembly 42 may be readily controlled in known fashion by an engine control module (not shown). Air space 58 acts as a thermal jacket for heater sub-assembly 42, reducing outward radiative/conductive heat loss and thus increasing the amount of desirable inward conductive heat transfer to fuel 36.

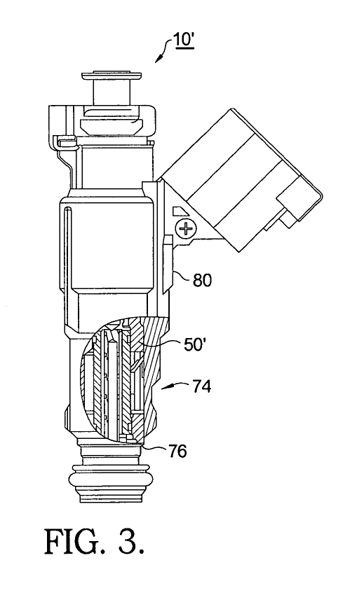

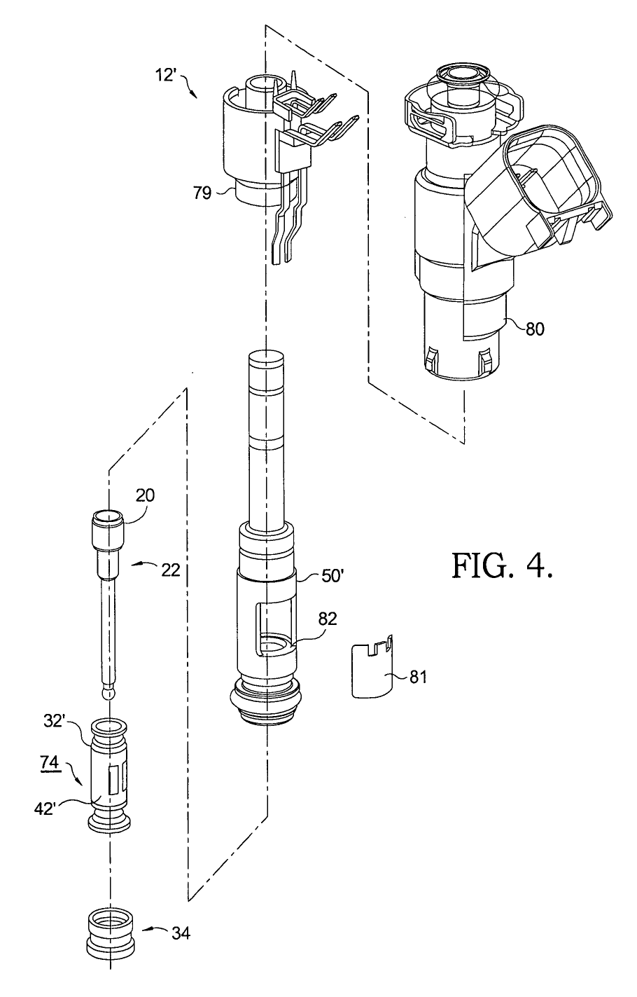

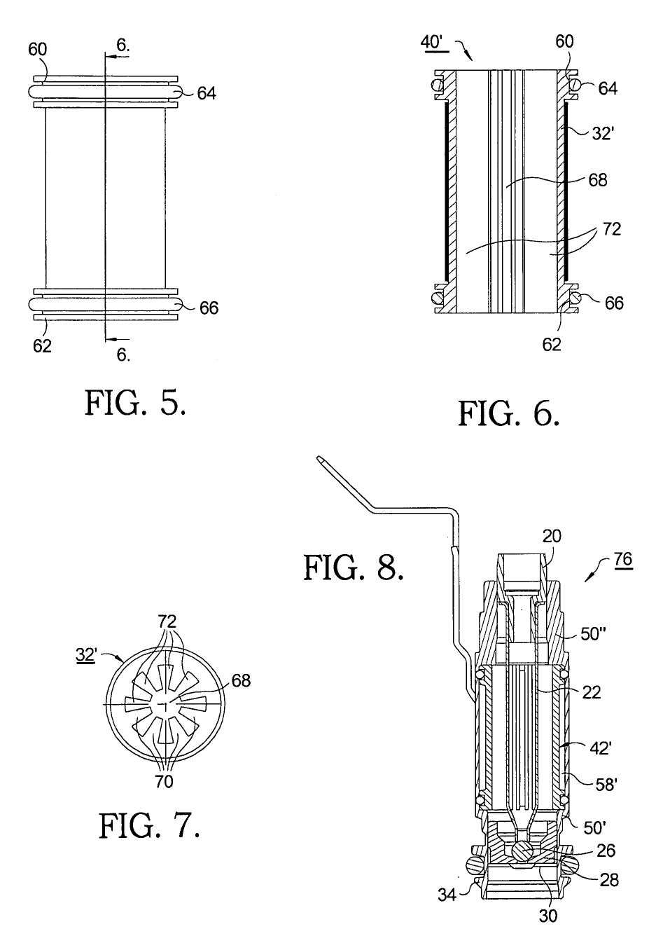

Referring now to FIGS. 3 through 8, a second embodiment 10′ is shown, in accordance with the present invention, of a heated and insulated fuel injector suitable for injecting low-volatility fuels. Most of the components of fuel injector 10′ are as recited above for first embodiment 10 to achieve the same functional capability and need not be shown nor repeated here. However, the differences are as described hereinbelow.

Fuel injector body 32′ comprises upper and lower grooved flanges 60, 62 for receiving upper and lower O-rings 64, 66 respectively. A fuel flow space 40′ through body 32′ is defined by a central opening 68 and preferably a plurality of inwardly-extending fins 70 spaced apart to provide a plurality of outwardly-extending channels 72, thus increasing the surface area of the flow space to increase the amount of heat transfer from a heater sub-assembly 42′ surrounding injector body 32′.

A body sub-assembly 74 comprising heater sub-assembly 42′, body 32′, and O-rings 64, 66 is inserted into an outer body shell 50′, creating a dead air space 58′ and defining a fuel injector sub-assembly 76 that may also include an armature 20, valve 22, valve head 26, valve seat 28, disperser plate 30, and retainer 34 as described for first embodiment 10. Sub-assembly 76 is mated to solenoid actuator subassembly 12′ having an outer sleeve 79, extending over and welded to shell 50. Terminals are then attached to the heater, and a cover 81 is installed over the access hole 82 in shell 50. This whole assembly is then injection molded to create the outside profile 80 of the injector.

In operation, similar to first embodiment 10, heat generated by electrical resistance in heater sub-assembly 42′ is transferred via thermal conductance through the wall of body 32′ and into fuel flowing through flow space 40′. Air space 58′ acts as a thermal jacket for heater sub-assembly 42′, reducing outward radiative/conductive heat loss and thus increasing the amount of desirable inward conductive heat transfer to the fuel in flow space 40′.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A fuel injector assembly for injecting fuel into an internal combustion engine, comprising:
a) an injector body including a valve seat disposed in said injector body;
b) a valve including a valve head for mating with said valve seat to control flow of fuel through said fuel injector assembly;
c) a heater sub-assembly disposed adjacent an outer surface of said injector body; and
d) an injector shell disposed around said heater sub-assembly and said injector body and radially off-spaced therefrom to define an air space.

2. A fuel injector assembly in accordance with claim 1 wherein said heater sub-assembly includes a ceramic element.

3. A fuel injector assembly in accordance with claim 1 wherein said injector body is formed of a metal selected from the group consisting of stainless steel and metals more thermally-conductive than stainless steel.

4. A fuel injector assembly in accordance with claim 3 wherein said metal is selected from the group consisting of aluminum alloys and titanium alloys.

5. A fuel injector assembly in accordance with claim 1 wherein said injector shell is formed as an upper shell and a lower shell.

6. A fuel injector assembly in accordance with claim 1 wherein said injector body includes a plurality of spaced-apart fins extending into a fuel flow space.

7. An internal combustion engine comprising a fuel injector assembly for injecting fuel into said engine, wherein said fuel injector assembly includes
an injector body including a valve seat disposed in said injector body,
a valve including a valve head for mating with said valve seat to control flow of fuel through said fuel injector assembly,
a heater sub-assembly disposed adjacent an outer surface of said injector body, and
an injector shell disposed around said heater sub-assembly and said injector body and radially off-spaced therefrom to define an air space.
